(19) United States
(12) Patent Application Publication
(10) Pub. No.: US 2025/0373038 A1
(43) Pub. Date: Dec. 4, 2025

(54) Battery Storage Device

(71) Applicant: Cynthia Bou, New York, NY (US)

(72) Inventor: Cynthia Bou, New York, NY (US)

(21) Appl. No.: 19/211,575

(22) Filed: May 19, 2025

Related U.S. Application Data
(60) Provisional application No. 63/654,147, filed on May 31, 2024.

(51) Int. Cl. H02J 7/00; H01M 10/0525; H01M 10/44; H01M 10/46; H01M 10/48; H01M 50/204; H01M 50/224; H01M 50/24; H01M 50/383

(52) U.S. Cl. CPC H02J 7/0045; H01M 10/0525; H01M 10/44; H01M 10/46; H01M 10/488; H01M 50/204; H01M 50/224; H01M 50/24; H01M 50/383

(57) ABSTRACT

A lithium battery storage device is disclosed, which is a safety cabinet designed to contain and store lithium batteries during charging, aiming to prevent home fires and contain potential explosions. The lithium battery storage device comprises a fireproof body component that is configured in a rectangular cabinet made from 18-gauge steel with an all-welded, galvanized steel frame and a self-closing door. The device is equipped with internal charging stations, a temperature gauge, a shelf, and ventilation fans to manage the heat. The ventilation fans expel extra heat, as needed. The exterior of the body component includes a color-coded charging meter that glows from red, to yellow, to green, to indicate charge level. Further, the body component is integrated with a smartphone app, providing users with alerts if temperature thresholds are exceeded. Thus, a user can charge two lithium batteries simultaneously in a safe and effective manner.

### CROSS-REFERENCE TO RELATED APPLICATION

The present application claims priority to, and the benefit of, U.S. Provisional Application No. 63/654,147, which was filed on May 31, 2024, and is incorporated herein by reference in its entirety.

### FIELD OF THE INVENTION

The present invention relates generally to the field of lithium battery storage devices. More specifically, the present invention relates to a multifunctional storage cabinet for lithium batteries and other electronic items. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in lithium battery storage devices. Generally, people who own E-bikes and other devices need a place to charge lithium batteries. However, while charging, the batteries could be at risk of overheating and ultimately exploding, causing serious injury and damage to a home. Further, people may be unaware that the battery has exploded, and a house fire could quickly spread.

Additionally, rechargeable batteries in almost any device can malfunction and ignite while the device is being recharged, causing significant risk of injury to users as the likelihood of homes burning down and family members dying in fires is very real. Therefore, a need exists for a new and novel solution to prevent a lithium battery from igniting the area around it while it is charging.

Accordingly, there is a demand for an improved lithium battery storage device that prevents house fires from spreading if a lithium battery accidentally explodes while charging. More particularly, there is a demand for a lithium battery storage device that stores and charges lithium batteries and prevents home fires.

Therefore, there exists a long felt need in the art for a lithium battery storage device that provides users with a multifunctional storage cabinet for lithium batteries and other electronic items. There is also a long felt need in the art for a lithium battery storage device that features a stainless steel encasing with internal charging stations, charging meters, a temperature gauge, and ventilation fans to manage heat, that work in conjunction to effectively charge batteries and contain accidental explosions. Further, there is a long felt need in the art for a lithium battery storage device that allows users to easily identify battery charge level via color coded charging meters on the exterior. Moreover, there is a long felt need in the art for a device that integrates with a smartphone app for full control over the cabinet and remotely identifying battery charge levels. Further, there is a long felt need in the art for a lithium battery storage device that prevents house fires from spreading if a lithium battery accidentally explodes while charging. Finally, there is a long felt need in the art for a lithium battery storage device that allows a user to charge two lithium batteries simultaneously.

The subject matter disclosed and claimed herein, in one embodiment thereof, comprises a lithium battery storage device. The device is a safety cabinet designed to contain and store lithium batteries during charging, aiming to prevent home fires and contain potential explosions. The lithium battery storage device comprises a body component that is configured in a rectangular cabinet made from 18-gauge steel with an all-welded, galvanized steel frame and a self-closing door. The body component is fireproof. The device is equipped with internal charging stations, a temperature gauge, a shelf, and ventilation fans to manage the heat. The ventilation fans expel extra heat, as needed. The exterior of the body component includes a color-coded charging meter that glows from red, to yellow, to green, to indicate charge level. Further, the body component is integrated with a smartphone app, providing users with alerts if temperature thresholds are exceeded. Thus, a user can charge two lithium batteries simultaneously in a safe and effective manner.

In this manner, the lithium battery storage device of the present invention accomplishes all of the forgoing objectives and provides users with a device that safely contains and charges lithium batteries. The device is a fireproof cabinet for containing the batteries. The device can charge two batteries simultaneously.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a lithium battery storage device. The device is a safety cabinet designed to contain and store lithium batteries during charging, aiming to prevent home fires and contain potential explosions. The lithium battery storage device comprises a body component that is configured in a rectangular cabinet and a self-closing door. The device is equipped with internal charging stations, a temperature gauge, and a ventilation fan to manage the heat. The exterior of the body component includes a charging meter to indicate charge level.

In one embodiment, the lithium battery storage device is a robust container or cabinet intended to safely store and charge lithium-ion batteries and other suitable batteries. The device also provides fire suppression to prevent the propagation of cell-to-cell fires and other heat and energy related destructive events. The device is also applicable to other types of batteries or electronics that have a tendency to overheat and catch fire.

In one embodiment, the lithium battery storage device comprises a body component that is a fire-retardant/fireproof enclosure. The interior of the body component is comprised of fire-retardant material that can resist temperatures of at least 1000 degrees Celsius. The fire-retardant material could be a fabric that is inherently fire retardant, such as but not limited to tightly woven wool (such as Kao wool), or polyesters. The fire-retardant material could also be fabrics that are chemically treated to be fire retardant by any means known in the field such as Polybrominated diphenyl ethers (PBDE). Further, lightweight materials can also be used, such as carbon foam, carbon/carbonized fiber, Kevlar, silicone infused fiberglass products, ceramic tiles, PVC/fiberglass material, and other comparable materials are contemplated by this disclosure. The exterior of the body component is typically a free-standing, stainless steel encasing that is made from 18-gauge steel with an all-welded, galvanized steel frame for durability, longevity, and fire safety. Additionally, the body component is configured in a rectangular shape that comprises a bottom, a top, opposing sidewalls, a back wall, and an open front allowing access to the interior of the body component.

In one embodiment, the interior of the body component includes at least one shelf or other means for storing objects, as needed. The shelf can be utilized to store other items on top and to create more room below the shelf for the lithium batteries and universal chargers.

In one embodiment, the open front is closed via a self-closing door. The self-closing door seals the body component to ensure its fire-retardant/fireproof. Further, the self-closing door comprises a latch, to secure the door closed to prevent fires when charging the batteries. Other configurations for securing the door, including but not limited to Velcro or a zipper are contemplated by this disclosure.

In one embodiment, the self-closing door is attached to one end of the open front via hinges, though any attachment means that allows for the opening and closing of the door is contemplated by this disclosure including a front closure that is not permanently connected and is just placed on the body component to form the enclosure, as needed. Typically, the hinges are designed to automatically close the door after it's been opened. Unlike regular hinges, these hinges have a built-in spring or hydraulic mechanism that exerts force to close the door when it's released. Specifically, when the door is opened, the spring or hydraulic mechanism within the hinge is compressed or engaged. Upon release, the stored energy in the mechanism is released, causing the door to close gradually and securely. This automated closing feature is particularly useful to ensure that the door is closed after use, to ensure the fireproof-ness of the body component during use.

In one embodiment, the lithium batteries are not only stored in the body component but may also be charged. Therefore, each body component also includes two universal chargers and connectors for connecting to battery leads to charge the lithium battery or batteries while they are stored in the body component. Typically, there are two universal chargers in the body component, but any suitable number of universal chargers can be utilized as is known in the art. Further, the universal chargers and connectors are part of any known charging arrangement, and include a power source, circuits, and controls to provide the most efficient charging current to the lithium batteries. In this embodiment, the universal chargers and connectors include their own internal power source with controls and circuits. In another embodiment, the universal chargers comprise charge connectors with circuits which extend through the body component to connect to an external power source located outside of the body component. Typically, the universal chargers and charge connectors are positioned in what is typically considered the back of the body component, though any feasible position of the universal chargers and charge connectors with circuits extending through the body component to an external power source is contemplated by this disclosure.

In one embodiment, an electric eye smoke sensor is fixedly disposed on an interior side of the body component. The electric eye smoke sensor is used to detect any immediate smoke and in turn, if smoke is detected, will cut any power being actively supplied from the universal chargers and charge connectors to the lithium battery within the body component. Thus, the electric eye smoke sensor identifies and detects smoke within the body component and cuts any power to the universal chargers and charge connectors when smoke is detected. Accordingly, in the event that smoke is detected, the electric eye smoke sensor will cut power to the power source.

In one embodiment, the electric eye smoke sensor for sensing smoke within the body component is positioned at the top portion/ceiling of the body component. The positioning of the sensor at the ceiling is optimal at the ceiling, however, the sensor may alternatively be positioned at other locations within the body component. The sensor may be a known sensor such as a photoelectric or an ionization detector that detects fire and smoke. Photoelectric detectors would detect the difference in the transmission of light due to smoke or fire. Ionization detectors would detect the presence of hydrocarbons created by combustion. It is within the scope of this invention that the sensor combines both photoelectric and ionization technologies in one device.

In one embodiment, a ventilation fan is positioned on a back wall of the interior of the body component and vents to the outside. The ventilation fan is utilized to manage heat. Typically, the ventilation fan acts to expel extra heat, as needed. The ventilation fan can be manually activated or automatic, depending on the interior temperature of the body component. Further, any suitable ventilation fan can be used as is known in the art, depending on the shape and size of the body component.

In one embodiment, a temperature gauge is positioned within the interior of the body component. The temperature gauge senses and detects the internal temperature of the body component while the lithium batteries are charging. If a predetermined temperature threshold is reached as shown by the internal temperature gauge, the user manually activates a ventilation fan to expel the extra heat. In another embodiment, if an internal temperature reaches a predetermined threshold as shown by the temperature gauge, the temperature gauge communicates with the ventilation fan to automatically activate the ventilation fan to expel the excessive heat.

In one embodiment, an alarm is fixedly installed on a surface of the body component, and the alarm is electrically connected with the temperature gauge. If a high level of temperature is detected, the alarm is sounded, alerting a user to the heat and/or flames present in the body component.

In one embodiment, a color-coded charging meter is positioned on an exterior surface of the body component. Typically, the color-coded charging meter is positioned on the self-closing door but could be positioned on any suitable place on the exterior of the body component. The color-coded charging meter glows from red to yellow to green to indicate charge level. Further, as the color-coded charging meter is positioned on an exterior surface of the body component, the color-coded charging meter is visible to a user while the lithium batteries are charging and allows users to easily identify battery charge level via the color-coding. Thus, users can track the charge process of the lithium batteries within the body component via the charging meter.

In one embodiment, the body component comprises a power supply. The power supply supplies power to the plurality of sensors, and to each of the universal chargers and charging circuits which are used to charge the lithium batteries stored therein.

The sensors communicate with the power supply to disrupt power to the charging batteries in the event of fire events.

In one embodiment, the body component comprises at least one observation window. The at least one observation window is made from insulating glass that provides transparency, to determine the state of the battery inside the body component.

In one embodiment, the body component is positioned on the floor for use. The body component can be positioned directly on the floor or positioned on a countertop or other suitable surface a specific distance from the floor.

In one embodiment, the body component can be integrated with a smartphone app which provides users with alerts if temperature thresholds are exceeded and warns of fire and/or smoke within the body component. Further, the smartphone app allows for full control over the body component and its sensors and provides for remote identifying of battery charge levels. Specifically, the lithium battery storage device includes a wireless communications module and additional sensors which would allow the device to pair with a mobile application on a smart device. Once paired, a user could control the lithium battery storage device via the mobile application. Further, the mobile device or smart device may be a cellular telephone, a remote control, or any other device that may have wireless communication capabilities and may be connected to the internet. The mobile or smart device may perform any type of wireless communication, including, but not limited to, WIFI, BLUETOOTH, RFID, NFC, etc. As such, the user may use a mobile or smart device to monitor and control the lithium batteries being charged within the body component.

In one embodiment, the body component is sized and shaped to charge two lithium batteries simultaneously in a safe and effective manner.

In operation, one or two lithium batteries are placed in the body component and connected to the universal chargers. Then, the door is closed and sealed. The lithium batteries are then charged within the body component. In this way, if the lithium batteries explode and/or catch fire, they are contained within the body component, preventing a house fire or other damage.

In yet another embodiment, the lithium battery storage device comprises a plurality of indicia.

In yet another embodiment, a method of safely charging and storing lithium batteries is disclosed. The method includes the steps of providing a lithium battery storage device comprising a fireproof body component with a self-closing door. The method also comprises inserting a lithium battery into the body component. Further, the method comprises charging the lithium battery while in the body component. The method also comprises expelling extra heat during the charging via the ventilation fans. Finally, the method comprises utilizing an exterior temperature gauge to determine if the lithium battery is at full charge.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the lithium battery storage device of the present invention showing the interior of the body component in accordance with the disclosed architecture;

FIG. 2 illustrates a perspective view of one embodiment of the lithium battery storage device of the present invention showing the exterior of the body component in accordance with the disclosed architecture;

FIG. 3 illustrates a perspective view of one embodiment of the lithium battery storage device of the present invention showing a fire when charging a lithium battery in accordance with the disclosed architecture;

FIG. 4 illustrates a perspective view of one embodiment of the lithium battery storage device of the present invention showing the lithium battery safely contained within the body component in accordance with the disclosed architecture; and

FIG. 5 illustrates a flowchart showing the method of safely charging and storing lithium batteries in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a lithium battery storage device that provides users with a multifunctional storage cabinet for lithium batteries and other electronic items. There is also a long felt need in the art for a lithium battery storage device that features a stainless steel encasing with internal charging stations, charging meters, a temperature gauge, and ventilation fans to manage heat, that work in conjunction to effectively charge batteries and contain accidental explosions. Further, there is a long felt need in the art for a lithium battery storage device that allows users to easily identify battery charge level via color coded charging meters on the exterior. Moreover, there is a long felt need in the art for a device that integrates with a smartphone app for full control over the cabinet and remotely identifying battery charge levels. Further, there is a long felt need in the art for a lithium battery storage device that prevents house fires from spreading if a lithium battery accidentally explodes while charging. Finally, there is a long felt need in the art for a lithium battery storage device that allows a user to charge two lithium batteries simultaneously.

The present invention, in one exemplary embodiment, is a novel lithium battery storage device. The lithium battery storage device comprises a body component that is configured in a rectangular cabinet made from 18-gauge steel with an all-welded, galvanized steel frame and a self-closing door. The body component is fireproof. The device is equipped with internal charging stations, a temperature gauge, a shelf, and ventilation fans to manage the heat. The ventilation fans expel extra heat, as needed. The exterior of the body component includes a color-coded charging meter that glows from red, to yellow, to green, to indicate charge level. Further, the body component is integrated with a smartphone app, providing users with alerts if temperature thresholds are exceeded. The present invention also includes a novel method of safely charging and storing lithium batteries. The method includes the steps of providing a lithium battery storage device comprising a fireproof body component with a self-closing door. The method also comprises inserting a lithium battery into the body component. Further, the method comprises charging the lithium battery while in the body component. The method also comprises expelling extra heat during the charging via the ventilation fans. Finally, the method comprises utilizing an exterior temperature gauge to determine if the lithium battery is at full charge.

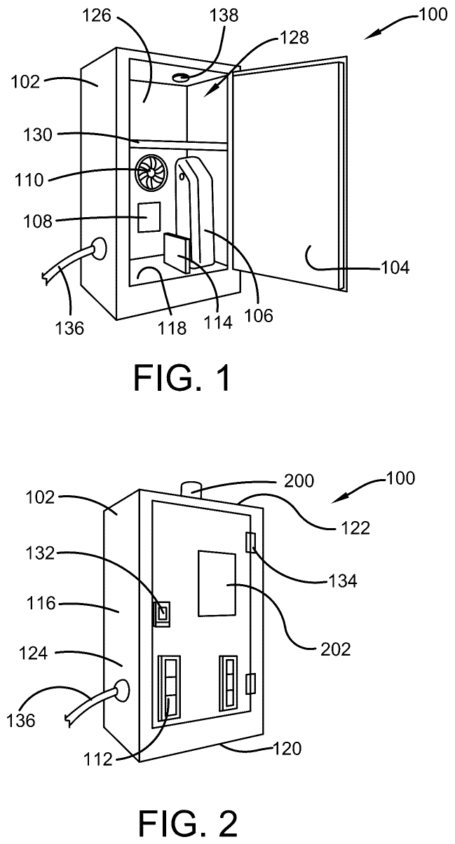

Referring initially to the drawings, FIG. 1 illustrates a perspective view of one embodiment of the lithium battery storage device 100 of the present invention. In the present embodiment, the lithium battery storage device 100 is an improved lithium battery storage device 100 that provides a user with a safety cabinet designed to contain and store lithium batteries 114. Specifically, the lithium battery storage device 100 comprises a body component 102 with a self-closing door 104. The device 100 is equipped with internal charging stations 106, a temperature gauge 108, and a ventilation fan 110 to manage the heat. The exterior 116 of the body component 102 includes a charging meter 112 to indicate charge level.

Generally, the lithium battery storage device 100 is a robust container or cabinet intended to safely store and charge lithium-ion batteries 114 and other suitable batteries. The device 100 also provides fire suppression to prevent the propagation of cell-to-cell fires and other heat and energy related destructive events. The device 100 is also applicable to other types of batteries or electronics that have a tendency to overheat and catch fire.

Further, the lithium battery storage device 100 comprises a body component 102 that is a fire-retardant/fireproof enclosure. The interior 118 of the body component 102 is comprised of fire-retardant material that can resist temperatures of at least 1000 degrees Celsius. The fire-retardant material could be a fabric that is inherently fire retardant, such as but not limited to tightly woven wool (such as Kao wool), or polyesters. The fire-retardant material could also be fabrics that are chemically treated to be fire retardant by any means known in the field such as Polybrominated diphenyl ethers (PBDE). Further, lightweight materials can also be used, such as carbon foam, carbon/carbonized fiber, Kevlar, silicone infused fiberglass products, ceramic tiles, PVC/fiberglass material, and other comparable materials are contemplated by this disclosure. The exterior 116 of the body component 102 is typically a free-standing, stainless steel encasing that is made from 18-gauge steel with an all-welded, galvanized steel frame for durability, longevity, and fire safety. Additionally, the body component 102 is configured in a rectangular shape that comprises a bottom 120, a top 122, opposing sidewalls 124, a back wall 126, and an open front 128 allowing access to the interior 118 of the body component 102.

Typically, the interior 118 of the body component 102 includes at least one shelf 130 or other means for storing objects, as needed. The shelf 130 can be utilized to store other items on top and to create more room below the shelf 130 for the lithium batteries 114 and universal chargers 106.

Furthermore, the open front 128 of the body component 102 is closed via a self-closing door 104. The self-closing door 104 seals the body component 102 to ensure its fire-retardant/fireproof. Further, the self-closing door 104 comprises a latch 132, to secure the door 104 closed to prevent fires when charging the batteries 114. Other configurations for securing the door 104, including but not limited to Velcro or a zipper are contemplated by this disclosure.

Additionally, the self-closing door 104 is attached to one end of the open front 128 via hinges 134, though any attachment means that allows for the opening and closing of the door 104 is contemplated by this disclosure including a front closure that is not permanently connected and is just placed on the body component 102 to form the enclosure, as needed. Typically, the hinges 134 are designed to automatically close the door 104 after it's been opened. Unlike regular hinges, these hinges 134 have a built-in spring or hydraulic mechanism that exerts force to close the door 104 when it's released. Specifically, when the door 104 is opened, the spring or hydraulic mechanism within the hinge 134 is compressed or engaged. Upon release, the stored energy in the mechanism is released, causing the door 104 to close gradually and securely. This automated closing feature is particularly useful to ensure that the door 104 is closed after use, to ensure the fireproof-ness of the body component 102 during use.

Further, the lithium batteries 114 are not only stored in the body component 102 but may also be charged. Therefore, each body component 102 also includes two universal chargers 106 and connectors for connecting to battery leads to charge the lithium battery or batteries 114 while they are stored in the body component 102. Typically, there are two universal chargers 106 in the body component 102, but any suitable number of universal chargers 106 can be utilized as is known in the art. Further, the universal chargers 106 and connectors are part of any known charging arrangement, and include a power source, circuits, and controls to provide the most efficient charging current to the lithium batteries 114. In this embodiment, the universal chargers 106 and connectors include their own internal power source with controls and circuits. In another embodiment, the universal chargers 106 comprise charge connectors with circuits which extend through the body component 102 to connect to an external power source 136 located outside of the body component 102. Typically, the universal chargers 106 and charge connectors are positioned in what is typically considered the back of the body component 102, though any feasible position of the universal chargers 106 and charge connectors with circuits extending through the body component 102 to an external power source 136 is contemplated by this disclosure.

In one embodiment, an electric eye smoke sensor 138 is fixedly disposed on an interior side 118 of the body component 102. The electric eye smoke sensor 138 is used to detect any immediate smoke and in turn, if smoke is detected, will cut any power being actively supplied from the universal chargers 106 and charge connectors to the lithium battery 114 within the body component 102. Thus, the electric eye smoke sensor 138 identifies and detects smoke within the body component 102 and cuts any power to the universal chargers 106 and charge connectors when smoke is detected. Accordingly, in the event that smoke is detected, the electric eye smoke sensor 138 will cut power to the power source.

Further, the electric eye smoke sensor 138 for sensing smoke within the body component 102 is positioned at the top portion/ceiling of the body component 102. The positioning of the sensor 138 at the ceiling is optimal at the ceiling, however, the sensor 138 may alternatively be positioned at other locations within the body component 102. The sensor 138 may be a known sensor such as a photoelectric or an ionization detector that detects fire and smoke. Photoelectric detectors would detect the difference in the transmission of light due to smoke or fire. Ionization detectors would detect the presence of hydrocarbons created by combustion. It is within the scope of this invention that the sensor 138 combines both photoelectric and ionization technologies in one device.

Additionally, a ventilation fan 110 is positioned on a back wall 126 of the interior 118 of the body component 102 and vents to the outside. The ventilation fan 110 is utilized to manage heat. Typically, the ventilation fan 110 acts to expel extra heat, as needed. The ventilation fan 110 can be manually activated or automatic, depending on the interior temperature of the body component 102. Further, any suitable ventilation fan 110 can be used as is known in the art, depending on the shape and size of the body component 102.

Further, a temperature gauge 108 is positioned within the interior 118 of the body component 102. The temperature gauge 108 senses and detects the internal temperature of the body component 102 while the lithium batteries 114 are charging. If a predetermined temperature threshold is reached as shown by the internal temperature gauge 108, the user manually activates a ventilation fan 110 to expel the extra heat. In another embodiment, if an internal temperature reaches a predetermined threshold as shown by the temperature gauge 108, the temperature gauge 108 communicates with the ventilation fan 110 to automatically activate the ventilation fan 110 to expel the excessive heat.

As shown in FIG. 2, in one embodiment, an alarm 200 is fixedly installed on a surface of the body component 102, and the alarm 200 is electrically connected with the temperature gauge 108. If a high level of temperature is detected, the alarm 200 is sounded, alerting a user to the heat and/or flames present in the body component 102.

Further, a color-coded charging meter 112 is positioned on an exterior surface 116 of the body component 102. Typically, the color-coded charging meter 112 is positioned on the self-closing door 104 but could be positioned on any suitable place on the exterior 116 of the body component 102. The color-coded charging meter 112 glows from red to yellow to green to indicate charge level. Further, as the color-coded charging meter 112 is positioned on an exterior surface 116 of the body component 102, the color-coded charging meter 112 is visible to a user while the lithium batteries 114 are charging and allows users to easily identify battery charge level via the color-coding. Thus, users can track the charge process of the lithium batteries 114 within the body component 102 via the charging meter 112.

In one embodiment, the body component 102 comprises a power supply 136. The power supply 136 supplies power to the plurality of sensors, and to each of the universal chargers 106 and charging circuits which are used to charge the lithium batteries 114 stored therein. The sensors communicate with the power supply 136 to disrupt power to the charging batteries in the event of fire events.

In another embodiment, the body component 102 comprises at least one observation window 202. The at least one observation window 202 is made from insulating glass that provides transparency, to determine the state of the battery 114 inside the body component 102, as well as the internal temperature.

Further, the body component 102 can be integrated with a smartphone app 204 which provides users with alerts if temperature thresholds are exceeded and warns of fire and/or smoke within the body component 102. Further, the smartphone app 204 allows for full control over the body component 102 and its sensors and provides for remote identifying of battery charge levels. Specifically, the lithium battery storage device 100 includes a wireless communications module 206 and additional sensors which would allow the device 100 to pair with a mobile application 204 on a smart device 208. Once paired, a user could control the lithium battery storage device 100 via the mobile application 204. Further, the mobile device or smart device 208 may be a cellular telephone, a remote control, or any other device that may have wireless communication capabilities and may be connected to the internet. The mobile or smart device 208 may perform any type of wireless communication, including, but not limited to, WIFI, BLUETOOTH, RFID, NFC, etc. As such, the user may use a mobile or smart device 208 to monitor and control the lithium batteries 114 being charged within the body component 102.

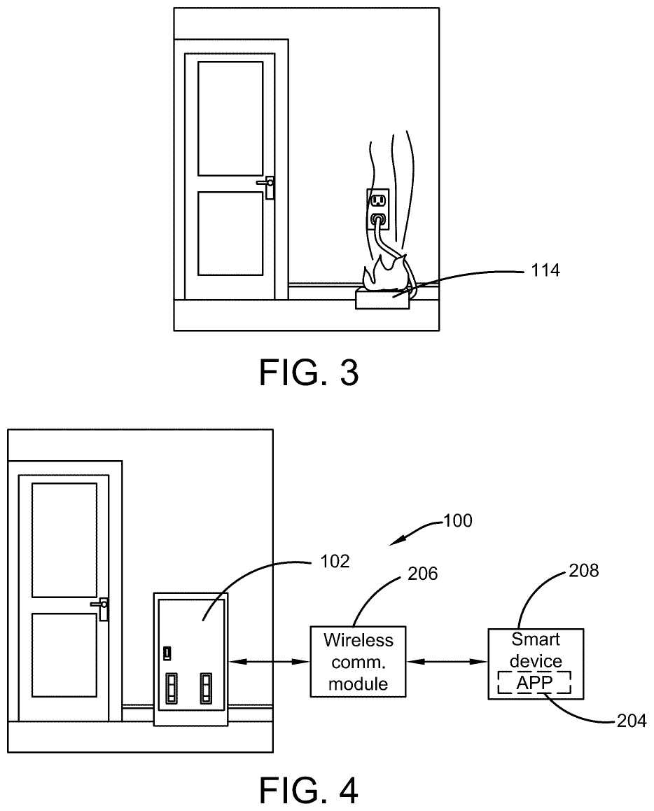

As shown in FIGS. 3-4, the body component 102 is positioned on the floor for use. The body component 102 can be positioned directly on the floor or positioned on a countertop or other suitable surface a specific distance from the floor.

Generally, the body component 102 is sized and shaped to charge two lithium batteries 114 simultaneously in a safe and effective manner. However, the body component 102 can be any suitable shape and size as is known in the art.

In yet another embodiment, the lithium battery storage device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be lithium battery, charging, or brand related.

In operation, one or two lithium batteries 114 are placed in the body component 102 and connected to the universal chargers 106. Then, the door 104 is closed and sealed. The lithium batteries 114 are then charged within the body component 102. In this way, if the lithium batteries 114 explode and/or catch fire, they are contained within the body component 102, preventing a house fire or other damage.

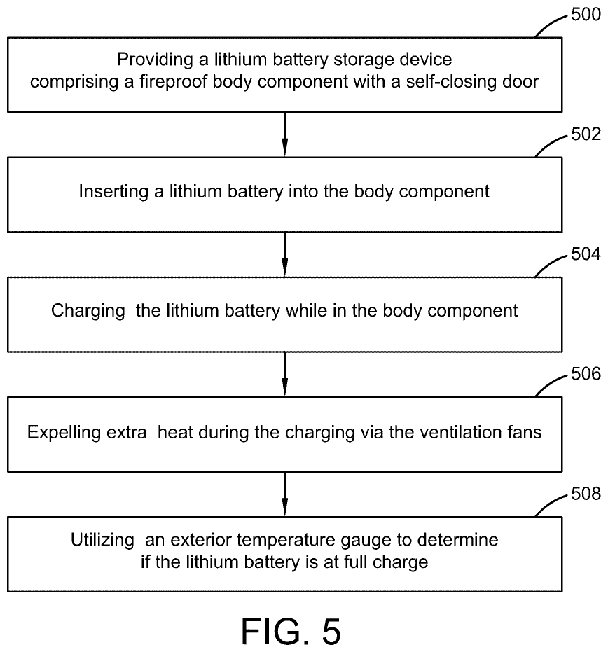

FIG. 5 illustrates a flowchart of the method of safely charging and storing lithium batteries. The method includes the steps of at 500, providing a lithium battery storage device comprising a fireproof body component with a self-closing door. The method also comprises at 502, inserting a lithium battery into the body component. Further, the method comprises at 504, charging the lithium battery while in the body component. The method also comprises at 506, expelling extra heat during the charging via the ventilation fans. Finally, the method comprises at 508, utilizing an exterior temperature gauge to determine if the lithium battery is at full charge.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “lithium battery storage device”, “lithium battery device”, “storage device”, and “device” are interchangeable and refer to the lithium battery storage device 100 of the present invention.

Notwithstanding the forgoing, the lithium battery storage device 100 of the present invention can be of any suitable size and configuration as is known in the art without affecting the overall concept of the invention, provided that it accomplishes the above stated objectives. One of ordinary skill in the art will appreciate that the lithium battery storage device 100 as shown in FIGS. 1-5 is for illustrative purposes only, and that many other sizes and shapes of the lithium battery storage device 100 are well within the scope of the present disclosure. Although the dimensions of the lithium battery storage device 100 are important design parameters for user convenience, the lithium battery storage device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lithium battery storage device that is a cabinet for storing and charging lithium batteries, the lithium battery storage device comprising:
a body component; and
at least one universal charger;
wherein the body component is fireproof and comprises a door to seal the body component shut;
wherein the at least one universal charger is positioned within the body component; and
further wherein the body component and its components work in conjunction to effectively charge a lithium ion battery and contain accidental explosions.

2. The lithium battery storage device of claim 1, wherein an interior of the body component is comprised of fire-retardant material.

3. The lithium battery storage device of claim 2, wherein an exterior of the body component is a free-standing, stainless steel encasing that is made from 18-gauge steel with an all-welded, galvanized steel frame.

4. The lithium battery storage device of claim 3, wherein the body component is configured in a rectangular shape that comprises a bottom, a top, opposing sidewalls, a back wall, and an open front allowing access to the interior of the body component.

5. The lithium battery storage device of claim 4, wherein the interior of the body component includes at least one shelf.

6. The lithium battery storage device of claim 5, wherein the open front of the body component is closed and sealed via a self-closing door.

7. The lithium battery storage device of claim 6, wherein each body component includes two universal chargers to charge two lithium batteries.

8. The lithium battery storage device of claim 7, wherein the body component comprises an electric eye smoke sensor fixedly disposed on an interior side of the body component to detect smoke.

9. The lithium battery storage device of claim 8, wherein a ventilation fan is positioned on a back wall of the interior of the body component and vents to outside.

10. The lithium battery storage device of claim 9, wherein a temperature gauge is positioned within the interior of the body component to sense and detect internal temperature of the body component while the lithium batteries are charging.

11. The lithium battery storage device of claim 10, wherein an alarm is fixedly installed on a surface of the body component and in communication with the temperature gauge, such that when a high level of temperature is detected, the alarm is sounded.

12. The lithium battery storage device of claim 11, wherein a color-coded charging meter is positioned on an exterior surface of the self-closing door.

13. The lithium battery storage device of claim 12, wherein the color-coded charging meter glows from red to yellow to green to indicate charge level.

14. The lithium battery storage device of claim 13, wherein the body component is integrated with a smartphone app which provides users with full control over the body component.

15. A lithium battery storage device that is a cabinet for storing and charging lithium batteries, the lithium battery storage device comprising:
a body component configured in a rectangular shape that comprises a bottom, a top, opposing sidewalls, a back wall, and an open front allowing access to the interior of the body component; and
two universal chargers;
wherein an interior of the body component is comprised of fire-retardant material;
wherein an exterior of the body component is a free-standing, stainless steel encasing that is made from 18-gauge steel with an all-welded, galvanized steel frame;
wherein the body component is fireproof and comprises a self-closing door to seal the body component shut;
wherein the two universal chargers are positioned within the body component;
wherein a ventilation fan is positioned on a back wall of the interior of the body component and vents to outside;
wherein a temperature gauge is positioned within the interior of the body component to sense and detect internal temperature of the body component while a lithium battery is charging;
wherein a color-coded charging meter is positioned on an exterior surface of the self-closing door;
wherein the color-coded charging meter glows from red to yellow to green to indicate charge level;
wherein the body component is integrated with a smartphone app which provides users with full control over the body component; and
further wherein the body component and its components work in conjunction to effectively charge the lithium battery and contain accidental explosions.

16. The lithium battery storage device of claim 15, wherein the body component comprises at least one observation window.

17. The lithium battery storage device of claim 15, wherein the body component includes a wireless communications module which allows the lithium battery storage device to pair with the smartphone app on a smart device.

18. The lithium battery storage device of claim 15, wherein the body component is positioned on a floor for use.

19. The lithium battery storage device of claim 15 further comprising a plurality of indicia.

20. A method of safely charging and storing lithium batteries, the method comprising the following steps:
providing a lithium battery storage device comprising a fireproof body component with a self-closing door;
inserting a lithium battery into the body component;
charging the lithium battery while in the body component;
expelling extra heat during the charging via the ventilation fans; and
utilizing an exterior temperature gauge to determine if the lithium battery is at full charge.
